(19) United States
(12) Patent Application Publication
(10) Pub. No.: US 2021/0146831 A1
(43) Pub. Date: May 20, 2021

(54) ELECTRONIC ACCELEROMTER-BASED TILT SWITCH FOR VEHICLES

(71) Applicant: Methode Electronics, Inc., Chicago, IL (US)

(72) Inventors: Richard Allan GOSTLIN, Bonnington (CA); Eric Duncan SHERRIFF, Nelson (CA); Donald James MCLAUGHLAN, Krestova (CA)

(21) Appl. No.: 16/630,452

(22) PCT Filed: Jul. 11, 2018
(86) PCT No.: PCT/IB2018/055125

§ 371 Date: Jan. 12, 2020

Related U.S. Application Data
(60) Provisional application No. 62/531,792, filed on Jul. 12, 2017.

(51) Int. Cl. B60Q 3/82; B60Q 3/30; H05B 47/105

(52) U.S. Cl. CPC B60Q 3/82; H05B 47/105; B60Q 3/30

(57) ABSTRACT

An electronic accelerometer-based tilt switch for vehicles is capable of controlling the state of an electrical circuit according to the angle of inclination of the switch, for example to control power to a lamp. The switch includes a housing mountable to a vehicle member that is movable between a first position and a second position. When the vehicle member is in the first position it is at a predetermined angle of inclination versus when the vehicle member is in the second position. The housing may include an accelerometer and a control circuit to receive signals from the accelerometer indicative of an instant angle of inclination of the vehicle member and to switch the state of the electrical circuit between first and second states corresponding to first and second positions of the vehicle member.

### CROSS-REFERENCE TO RELATED PATENT APPLICATIONS

This international patent application claims the benefit of and priority to U.S. Provisional Patent Application Ser. No. 62/531,792, filed Jul. 12, 2017, the entirety of which is incorporated herein by reference.

### BACKGROUND OF THE INVENTION

### Field of the Invention

The present application relates to an electronic accelerometer-based tilt switch for vehicles. More particularly, the electronic accelerometer-based tilt switch uses an accelerometer to determine the physical orientation of a vehicle member as means for activating the switch based upon the determined position of the vehicle member.

### Description of Related Art

Tilt switches can be employed for a variety of applications in vehicles such as lighting. A common application is for turning a lamp on and off, for example, to turn a lamp on when the hood of a vehicle is raised to an open position. In the past, mercury-based tilt switches were employed. These types of switches used a small amount of mercury inside a sealed capsule. When the hood was lifted, the switch would be tilted to an angle which caused the mercury to flow into a position where it completed an electrical circuit and turned the lamp on. These types of mercury-based tilt switches were very popular because they were inexpensive, robust and reliable. Mercury-based tilt switches are no longer used today because of the danger to human health if the mercury escapes from the sealed capsule, and because improper disposal of the mercury switches at end of life can result in contamination of the environment. Accordingly, the automotive industry has had to look for a replacement for mercury-based tilt switches.

These days, in the automotive industry, mercury-based tilt switches have been mostly replaced with some form of ball switch. A ball or sliding member is typically provided in a cavity, where it can roll or slide between an “on” position and an “off” position depending upon the tilt of a body, such as a vehicle hood for an engine compartment. In one form, the ball itself can be electrically conductive so that it completes an electrical circuit for the switch when the ball is in the “on” position. In other solutions, a ball or sliding member is also used but in association with other devices to complete an electric circuit and thereby act as a tilt switch when the ball moves from one position to another position. For example, U.S. Pat. No. 4,820,888 discloses a tilt switch that uses a magnet that is slide-able to an “on” position when it is proximate to a reed switch, and slide-able away from the reed switch when it is in an “off” position. Various configurations for sliding or rolling magnetic members and reed switches have been developed as demonstrated by U.S. Pat. Nos. 3,564,171; 5,256,839; 5,477,428; 5,669,696; and 5,798,912. Other tilt switches have replaced reed switches with Hall Effect sensors such as U.S. Pat. No. 5,373,125 wherein a pivoting member has a permanent magnet that pivots within a housing containing a Hall Effect sensor and the alignment of the magnet with the Hall Effect sensor is used to activate the tilt switch. Similarly, U.S. Pat. No. 6,858,835 discloses a sliding magnetic element and a Hall Effect sensor, and like many of the known tilt switches, even though operation of the switch is dependent upon a moving magnetic element within the switch assembly, it is described as an electronic tilt switch because it employs a solid state Hall Effect electronic sensor to detect when the sliding element has moved past a predetermined position within a bore. The '835 patent teaches that the sensor can could also be a photo-optical interrupter. While such sensors do employ electronic sensors, these types of tilt switch still rely upon a mechanical rolling or sliding element that can still be a cause of failure resulting in premature end of life. U.S. Pat. No. 6,140,635 teaches the use of an optical sensor, but it also uses a rolling or sliding element that moves between positions where it blocks the light between a light source and a light receiver, and other positions where it does not block the light. Other examples of photo-optical interrupter switches that also use a rolling or sliding member to interrupt a light source include U.S. Pat. Nos. 5,202,559; 5,209,343; 5,373,153; 6,011,254; and 6,140,635. The automotive industry has tried many different forms of tilt switches to replace mercury-based tilt switches, and while some of them use electronic sensors or photo-optical sensors, known tilt switches for automotive lighting have all relied upon some form of moving macro-element, whether it be a rolling ball, a sliding member or a pivoting member, that changes position depending upon the orientation of a body such as the vehicle hood.

The types of tilt switches that use a ball to complete an electrical circuit rely upon good contact between the ball and the switch contacts and these can have a limited life-cycle count, after which they become worn out and cease to work consistently. Before ceasing to work entirely, a tilt switch failure mode can include intermittent operation. Some types of ball-based tilt switches can be susceptible to false activation due to vibration. Sometimes the device paired with the moving member is the cause of failure, such as failure of the reed switch because of fatigue over repeated cycles. In this disclosure, reference to ball-based switches in general is intended to refer to all tilt switches that employ a moving macro-member that rolls, slides or pivots whether it be ball-shaped or not. Because a ball-based tilt switch is a mechanical device, there can be a variety of causes for the moving element to become stuck, so that the switch ceases to function properly. By way of example, some of the causes for a sliding, rolling or pivoting element to become stuck include contaminants infiltrating the cavity, the moving element becoming corroded, the housing and/or bore becoming warped or otherwise deformed as a result of overheating or physical stresses, and path friction increase or path blockage due to debris formed by vibration.

The automotive industry is one that presents difficult challenges to component suppliers. First, robust solutions are required to survive harsh and difficult environments, where components can be subjected to continuous vibration, extreme temperatures covering a broad range from cold to hot. Depending upon the location where the tilt switch is installed, temperature specifications for automotive components can range, for example, from −40 degrees Celsius to over 100 degrees Celsius. Such a broad temperature range is typical for components installed in the engine compartment or near other heat sources such as near the exhaust system. The automotive industry also prefers that components deliver a long service life and, ideally, that they be maintenance free for the life of the vehicle. The automotive industry can also be very price competitive when it comes to each and every component that contributes to the overall cost of a vehicle. Tilt switches that use a moving element such as a ball have been attractive because they are inexpensive, but they have shortcomings when it comes to reliability and longevity. Accordingly, for many applications, and automotive applications in particular, a better solution is needed to replace known tilt switches that rely upon a rolling ball, or sliding or pivoting element, as part of the tilt switch apparatus.

Accelerometers have not been used by the automotive industry for tilt switches. One reason why past tilt switch solutions have not considered accelerometers is that, historically, accelerometers have been much more expensive compared to the components used by mechanically-based tilt switches. However, accelerometers have been used by the automotive industry as motion sensors for air bag systems, for example to detect extreme decelerations associated with impact, or for triggering deployment of an air bag.

There is a need in the automotive industry for an improved tilt switch for controlling the state of an electrical circuit according to the angle of inclination of a vehicle member such as the hood of an engine compartment, a trunk lid or hatch, and interior cabin lighting, for example for lighting mounted on a visor or for illuminating the interior of a glove box or other storage compartment.

### SUMMARY OF THE INVENTION

An electronic accelerometer-based tilt switch for vehicles is capable of controlling the state of an electrical circuit according to the angle of inclination of the switch. The electronic accelerometer-base tilt switch comprises a housing mountable to a vehicle member that is movable between a first position and a second position. When the vehicle member is in the first position it is at a predetermined angle of inclination versus when the vehicle member is in the second position. An accelerometer is disposed within the housing. A control circuit is disposed within the housing and is operatively connected to receive signals from the accelerometer indicative of an instant angle of inclination of the vehicle member and to switch the state of the electrical circuit to a first output state when said vehicle member is in a first position, and to switch the state of the electrical circuit to a second output state when the vehicle member is in the second position.

The control circuit functions to control power to the electrical circuit, and can comprise electromechanical control devices configured to act as an electrical relay, or discrete analog semiconductor components configured to act as an electrical relay.

In preferred embodiments, the electronic accelerometer-based tilt switch further comprising a microprocessor connected to receive signals from the accelerometer. The microprocessor processes the signals to determine the angle of inclination of the vehicle member. The microprocessor is also connected to send a command signal to the control circuit. When a microcontroller is employed, the electronic accelerometer-based tilt switch can be programed to do more than just switch the output state of an electrical circuit. The microprocessor can be programmed to filter the accelerometer signal to filter out noise and to determine when the vehicle is in motion. The microprocessor can also be programed with special effects, for example, when the switch is used to control a lamp, special effects can include fading on when the lamp is turned on, or fading out or turning the lamp off after a predetermined length of time. The microprocessor can be part of a microcontroller that also has program memory. The microcontroller can be programmable with different thresholds for sending commands to the control circuit for different angles of inclination, whereby the electronic accelerometer-based tilt switch can be employed for different applications without any hardware changes. In embodiments that comprise a microcontroller, the microprocessor can also be programmed to detect a change in the position of the vehicle member, not only by detecting a change in the angle of inclination, but alternatively, by detecting that the vehicle member is moving in a direction associated with moving between a closed and an open position. That is, instead of measuring an angle of inclination and determining when the measured angle of inclination has deviated beyond a predetermined threshold, the microprocessor can be programmed to detect accelerations associated with movement of the vehicle member between an closed position and an open position. The microprocessor can also be programmed with an adaptive algorithm to detect and compensate for the angle of inclination of the vehicle as a whole, so that the tilt switch will not be activated when the vehicle member is at an angle of inclination because the vehicle as a whole is on an angle because, for example, the vehicle is parked on a slope. The microprocessor could accomplish this by using a relative change of angle to detect a moving member, or use a long term trim value to compensate.

In some embodiments of the disclosed electronic accelerometer-based tilt switch, the accelerometer sends an output signal to a remote microcontroller, which is in communication with the control circuit. An advantage of this arrangement is that one microcontroller can be used with more than one electronic accelerometer-based tilt switch.

In preferred embodiments, the accelerometer is a 3-axis accelerometer. This provides a more robust measurement of acceleration for filtering out noise and enables motion detection when it is desirable to hold the circuit in one output state when motion is detected regardless of the angle of inclination. Because of the relatively low cost and for the sensitivity required for use in a tilt switch, compared to other types of accelerometers, in preferred embodiments the accelerometer is a MEMS cantilever beam accelerometer. The instant angle of inclination can be determined based upon acceleration measured by the accelerometer along a predetermined axis. The control circuit can be calibrated to determine that that the vehicle member has moved from the second position to the first position when the instant angle of inclination has changed by more than a predetermined threshold value.

In a preferred embodiment, the electrical circuit comprises a lamp assembly and the lamp assembly is turned on when the electrical circuit is in the first output state and turned off when the electrical circuit is in the second output state. In one application the vehicle member is a hood for an engine compartment and the first output state is in association with a predetermined angle of inclination when the hood is in an open position. In another application, the vehicle member is a trunk or hatch lid and the first output state is in association with a predetermined angle of inclination when the trunk or hatch lid is in an open position. In yet another application, the vehicle member is an interior compartment door moveable to an open position at a first predetermined angle of inclination from a closed position at a second predetermined angle of inclination and the first output state is in association with the first predetermined angle of inclination.

For applications where it is desirable to hold the electrical circuit in one of the output states when the vehicle is in motion, the magnitude of the accelerometer signal can be used to detect motion. For example, in one embodiment, the control circuit maintains the second output state when the accelerometer signal value deviates from one by more than a predetermined threshold. Instead of relying upon the accelerometer to detect motion, the tilt switch can further comprise another type of motion sensor, and the control circuit maintains the second output state when the motion sensor indicates that the vehicle is in motion.

In preferred embodiments, the electronic accelerometer-based tilt switch of claim 1 further comprises an electrical connector for receiving electrical power from an external power source and delivering the electrical power to components within the housing. The electrical connector can further comprise connections for sending and receiving signals from an external microprocessor.

The electronic accelerometer-based tilt switch can further comprise a battery disposed inside the housing that provides electrical power to components within the housing.

### BRIEF DESCRIPTION OF THE DRAWINGS

FIG. 1 is a drawing that shows a front perspective view of the front of a vehicle with its hood in the closed position with an electronic accelerometer-based tilt switch.

FIG. 2 is a drawing that shows the side view of the front of a vehicle with its hood in the open position with an electronic accelerometer-based tilt switch.

FIG. 3 is a schematic block diagram for one embodiment of an electronic accelerometer-based tilt switch for a vehicle.

FIG. 4 is a schematic block diagram for a second embodiment of an electronic accelerometer-based tilt switch for a vehicle.

FIG. 5 is a drawing that shows a side view of the rear of a vehicle 4 with a lifted hatch and an accelerometer-based tilt switch.

FIG. 6 is a drawing of a storage compartment in an interior space within a vehicle with an accelerometer-based tilt switch.

### DETAILED DESCRIPTION OF THE INVENTION

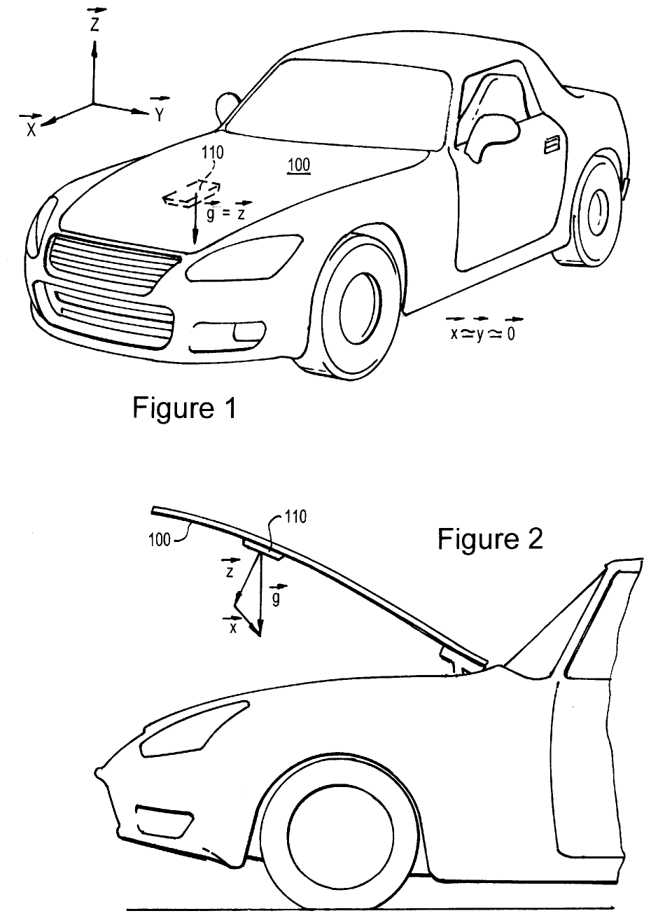

Referring to FIGS. 1 and 2, a vehicle is shown with a hood lamp application for the disclosed electronic tilt switch. This will be understood by people familiar with the vehicle industry to be a representative application for a tilt switch, and that other applications include lamps for cargo areas associated with a trunk or hatch lid or a tailgate, interior lamps associated with gull wing doors, vanity lights attached to visors, and lights for illuminating compartments located in an interior space inside a vehicle cabin that are opened by a hinged door, such as a glove box compartment, a center console storage compartment, a storage compartment below the floor in a foot well or in a trunk space, or a storage compartment accessed from outside the vehicle, for example, storage compartments for fire trucks or other utility trucks. Vehicle applications include applications for trailers and fifth wheels.

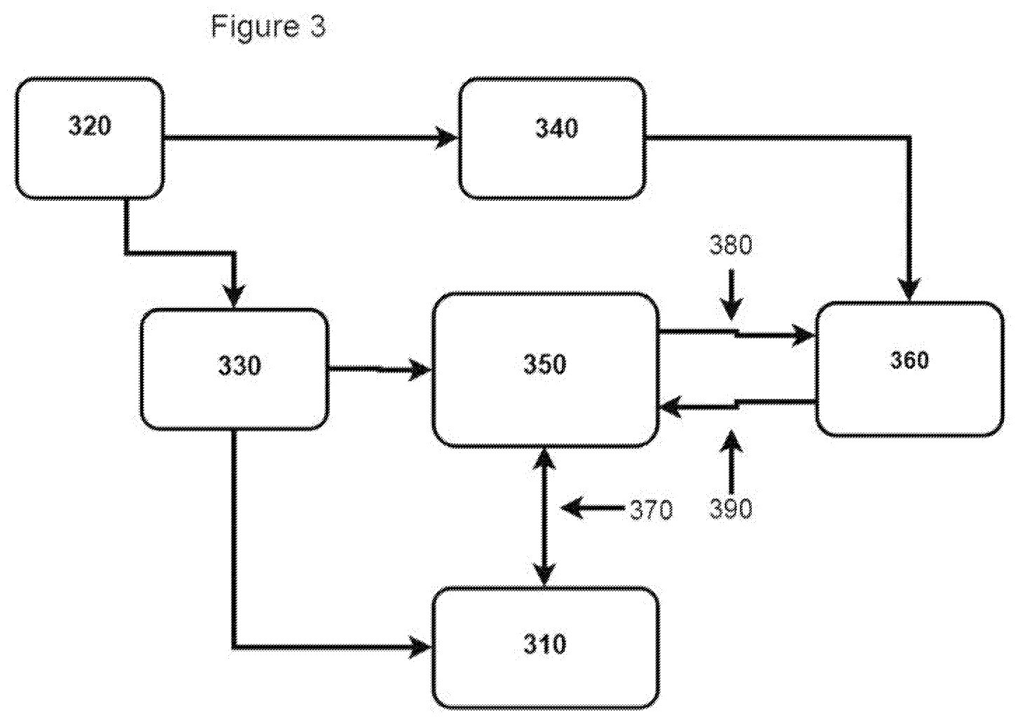

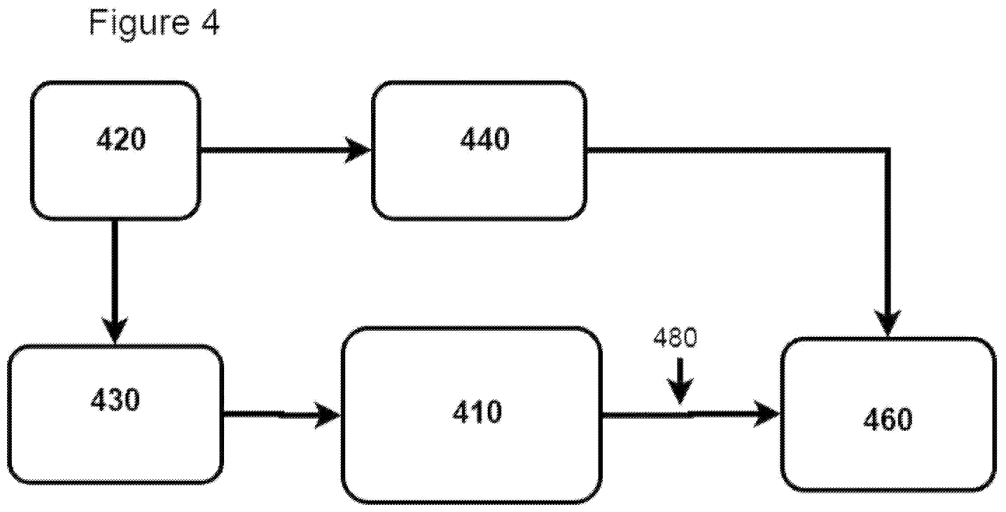

With reference to the figures, a perspective view of the front of a vehicle is shown in FIG. 1, with hood 100 closed, and in FIG. 2 a side view of the front of the vehicle shown in FIG. 1, shows hood 100 in an open position. Electronic accelerometer-based tilt switch 110 (not to scale) is mounted on the under-side of hood 100 so it is shown indicated by dashed lines in FIG. 1. When hood 100 is raised to an open position, electronic accelerometer-based tilt switch 110 is tilted to the same angle of inclination as hood 100. Electronic accelerometer-based tilt switch 110 comprises an accelerometer and other components as shown in the embodiments of FIGS. 3 and 4. The electronic accelerometer-based tilt switch can be mounted at a location on the underside of the hood, where it can measure the inclination angle of hood 100 and where it can be a good location for mounting a lamp that can be installed in the same housing as tilt switch 110. In preferred embodiments, electronic accelerometer-based tilt switch 110 comprises a three axis accelerometer that measures instantaneous acceleration in three orthogonal axes. In FIG. 1, the three axes are shown as “x” being horizontal, “y” being perpendicular to “x” in the horizontal plane and, and “z” being perpendicular to the horizontal plane, that is in a vertical direction. The instantaneous accelerations are caused by gravity, motion, or noise, which might be caused by effects such as vibrations. As depicted in FIG. 1, when vehicle hood 100 is closed, electronic tilt switch 110 is in a substantially horizontal orientation, such that the gravitational forces along the x and y axes are zero, and substantially all of the gravitational forces “g” measurable by electronic accelerometer-based tilt switch 110 are acting along the z axis.

The orientation of the axes relative to electronic accelerometer-based tilt switch 110 remain constant when hood 100 is raised to the open position shown in FIG. 2, so the acceleration caused by gravity when vehicle hood 100 is in the open position is divided between the z and x axes. When the accelerometer signal indicates that the value of acceleration along the x axis is no longer zero, and has increased beyond a threshold value, microprocessor 350, shown in FIG. 3, determines that the hood is in the open position and is programmed to send a signal to lamp control circuitry 360 to turn on lamp 340 to illuminate the engine compartment. FIG. 3 shows a schematic block diagram of a preferred embodiment of electronic accelerometer-base tilt switch 110 integrated with lamp 340. The block diagram in FIG. 3 shows that this switch and lamp assembly comprises accelerometer 310, power input through electrical connector 320, voltage regulator 330, lamp 340, microprocessor 350 and lamp control circuitry 360, which can all be disposed within a hermetically sealed housing. As is known to persons skilled in manufacturing electronic components, all of these components can be integrated onto one circuit board, or, in an alternative arrangement, some or all of these components can be discrete components connected according to the block diagram or in a functionally equivalent arrangement.

Accelerometer 310 is oriented within the housing to establish the desired orientation for the axes according to the application, meaning that the axes are oriented such that when the electronic accelerometer-based tilt switch is mounted to a vehicle member a change in position of the vehicle member results in a change in the position of accelerometer 310 beyond a threshold amount. When the measured accelerations along the axes indicate a change in position beyond a predetermined threshold amount this determines that the vehicle member has moved to an open position. Accelerometer 310 is electrically connected to send signals to microprocessor 350 and is also connected to a power source (not shown) through electrical connector 320 that delivers power to the components within the housing. Reliability can be greatly increased compared to known tilt switch technologies by removing friction, sticking and other failure modes associated with known mechanically-based tilt switches that still rely upon a sliding or rolling element. A preferred type of accelerometer is a micro electro-mechanical system (MEMS) that consists of a cantilever beam with a proof mass that deflects in response to all forces acting on it, including dynamic and gravitational forces. A MEMS accelerometer measures the deflection of the cantilever beam to determine the magnitude of the forces acting on it. When the accelerometer is stationary, all of the forces acting on it will be gravitational. When the accelerometer is moving then there will also be dynamic forces acting on the cantilever beam contributing to its deflection. MEMS accelerometers can be made inexpensively compared to other types of accelerometers and with smaller dimensions, making it possible to use them in the applications described in this application. MEMS accelerometers have a longer lifecycle compared to typical ball-type tilt switches, which have an expected lifecycle of about 100,000 cycles, which can be quickly exhausted when a tilt switch is subjected to vibrations that are common in a vehicular environment.

Electrical power from electrical connection 320 passes through voltage regulator 330 before being delivered to accelerometer 310 and microprocessor 350. Voltage regulator 330 conditions the power in the system for use with the other components. Some microprocessors are known to be integrated with a voltage regulator so as mentioned elsewhere in this disclosure, while the provided block diagrams illustrate certain elements as discrete components to better illustrate how the tilt switch works, some or all of these components can be integrated and function in the same way. Microprocessor 350 is programmed with a tilt algorithm to interpret the signals received from accelerometer 310 via communication link 370, and lamp control circuitry 360 receives a drive signal from microprocessor 350, as indicated by line 380. Lamp control circuitry 360 is operative as a switch for controlling whether lamp 340 is turned on or off. Optionally, lamp control circuitry 360 gives feedback along line 390 to microprocessor 350. Control circuitry 360 can any type of electrically operated switch, such as, for example, discrete analog semiconductor components (solid-state relays) or electromechanical control devices serving as an electrical relay. When lamp control circuitry 360 has its own feedback contained within its circuit or if it is an open loop design, then feedback to microprocessor 350 along line 390 is not needed. Lamp 340 is controlled by microprocessor 350 and while any type of lamp can be used, in preferred embodiments lamp 340 comprises a light emitting diode (“LED”) because LEDs are robust and durable, have a long service life, and consume less power compared to conventional lamps, such as incandescent bulb lamps. In this block diagram the lines between components indicate electrical connections through which current flows to provide power unless indicated herein as communication or signal lines. The block diagrams provided are schematic, meaning that they are drawn to explain to persons skilled in the design of electrical circuits how the electronic accelerometer-based tilt switch system works without showing each and every component, such as rectifiers and grounds.

In preferred embodiments microprocessor 350 is programmed to filter the signal received from the accelerometer through communication link 370. For example, a noise filter can be applied to remove the effects that might be caused by vibration. An averaging filter can be used as a noise filter in this application. When the tilt switch is used for a hood lamp or a trunk or hatch lid lamp, it can be assumed that these lights should not be turned on when the vehicle is in motion. Accordingly, microprocessor 350 can be programmed to maintain the switch in an off position when it determines from the accelerometer signal that the vehicle is in motion. Microprocessor 350 can detect vehicle motion by calculating the vector magnitude of the sum of the three acceleration vectors by taking the square root of the sum of the squares of the three vectors as set out in formula 1:

magnitude=\sqrt{x²+y²+z²} Formula 1

In the absence of acceleration caused by motion, the magnitude calculated by Formula 1 will have a value of one plus or minus tolerances and the effects of noise. Accordingly, the presence of motion can be easily determined when the magnitude departs from a value of one by more than a predetermined threshold value.

Unlike known tilt switches that do not employ a microprocessor, an advantage of the disclosed electronic tilt switch is that microprocessor 350 can be programmed to provide additional features. For example, microprocessor 350 can be programmed to monitor the time that a circuit is in an activated state, so that for applications like a hood lamp, there can bean automatic “time out” to turn the lamp off if the hood is left open too long. The microprocessor can also be programmed with special effects such as fading in with slowly increasing light intensity when the lamp is turned on and fading out when the light is turned off.

In another embodiment, shown by the schematic block diagram in FIG. 4, the electronic accelerometer-based tilt switch need not have a discrete microprocessor. All MEMs accelerometers have a built-in microprocessor and this microprocessor could be made to also serve the function of microprocessor 350 in the embodiment shown in FIG. 3. This integrated microprocessor could be enabled with all of the functionality of a discrete microprocessor, including programing for special effects for controlling the lamp such as a fade on, or a time out. Alternatively, if a simpler and less expensive system is preferred, electronic circuitry 460 can be designed to take the signal from accelerometer 410 and act as an electrical relay for turning on and off lamp 440 based upon signal output 480 from accelerometer 410. In yet another alternative arrangement, accelerometer 410 can send a signal to an external microprocessor (not shown) that is programmed to determine the position of the vehicle hood based on the received accelerometer signal, and then send command signals to control circuitry 460 to turn on or off lamp 440. This could be advantageous if there are a plurality of tilt switches in the same proximity, with all of them being in communication with a shared microprocessor.

The command signals between the components shown in FIGS. 3 and 4 can be sent by a digital communication signal, including, but not limited to serial, LIN, CAN, I2C, and SPI, or an analog signal, including, but not limited to 0-10 VDC, 4-20 mA, and PWM, or a digital signal, including but not limited to active high, active low and open drain. In the embodiment of FIG. 4 electrical connector 420 can be used to supply electrical power as well as for communication with a remote microprocessor. In FIG. 4, voltage regulator 430 serves the same function as voltage regulator 330 of FIG. 3, as described with respect to that embodiment.

People skilled in the design of electrical circuits will understand that the schematic block diagrams of FIGS. 3 and 4 are examples of concepts that can be enabled by various physical circuits which all give effect to the illustrated concepts, and that the claimed scope is directed to the concepts and all equivalent electrical circuits for connecting the components. For example, both schematic diagrams show the power being fed to lamps 340, 440, and then controlling them by switching the ground, known as a low side drive. The same concept could be achieved by using a high side drive where power feeds control circuitry 360, 460 and then controlling the current that flows to lamps 340, 440.

An advantage of using a microprocessor with the disclosed electronic accelerometer-based tilt switch is that the threshold inclination angles that are programmed into the software for the microprocessor can be easily changed for different applications. That is, the same electronic tilt switch can be used for different vehicles and for different applications by changing only the software without any hardware changes. Some of the known tilt switches that rely upon the movement of a ball or other member can require hardware changes to the geometry or orientation of the tilt switch to configure it for different applications, which adds to the cost.

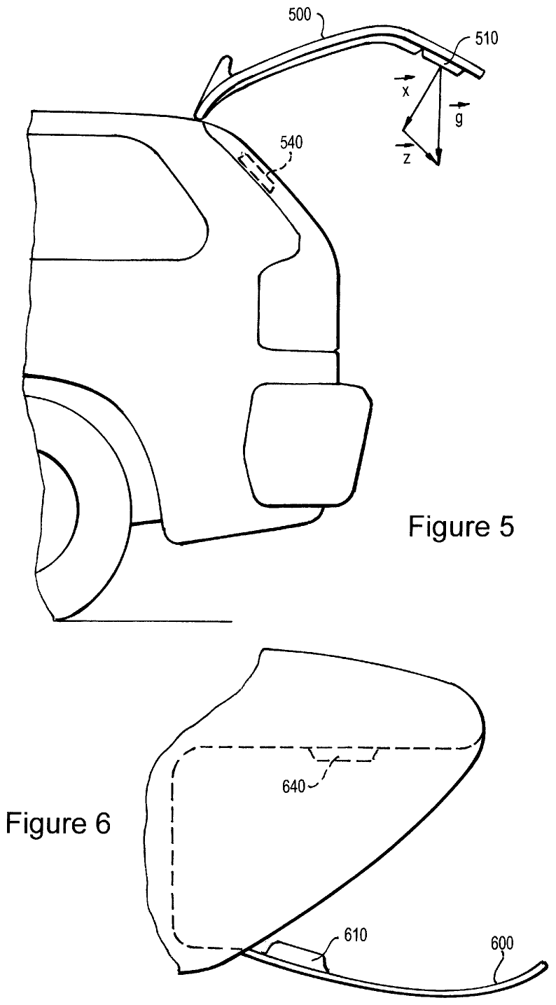

FIG. 5 is a side view of the rear of a vehicle with hatch 500 and electronic accelerometer-based tilt switch 510 that is employed to turn on lamp 540 to illuminate a cargo space in the vehicle when hatch 500 is lifted beyond a threshold angle of inclination. While one lamp is shown in the block diagrams, depending upon the application, it will be understood that lamps 340 and 440 could be more than one lamp if more lamps are needed to illuminate the space associated with the tilt switch. For example, in the cargo space in a hatchback several lights may be turned on when the hatch is lifted, and all of the lamps can be controlled by the same tilt switch. Obviously, in such an arrangement the tilt switch might be integrated with just one lamp or in a separate housing from all of the lamps.

FIG. 6 is an example of a passenger compartment application for the electronic accelerometer-based tilt switch. FIG. 6 shows a side view of a storage compartment which could be, for example, a glove box. Other storage compartments, not shown, could also include a center console storage bin, or a storage bin below the floor in a foot well or in the cargo area, which has a hinged lid. The electronic accelerometer-based tilt switch works on the same principle in this application. When compartment door 600 is swung to an open position electronic accelerometer-based tilt switch 610 detects a change in the inclination of the door beyond a predetermined threshold and the light is turned on. This is another example of an embodiment where light 640 is remote from the housing for electronic accelerometer-based tilt switch 610, which is mounted on compartment door 600.

The described applications are given as examples and should not be interpreted as limiting the scope of the claimed concept to just these examples since there are many like-applications in vehicles to which the described concepts can be applied. In all of these applications, the filtering described with respect to the hood application can be employed to filter out signals from the accelerometer that can be attributed to factors other than the position of the moving vehicle member, such as changes in the signal caused by movement of the vehicle, or from vibration.

Three-axis accelerometers are common, but as shown by the example of FIGS. 1 and 2, the angle of inclination of the vehicle hood can be determined without the need for a third axis in the y-direction. Two-axis accelerometers are also available and can be used for applications such as the hood lamp shown in FIGS. 1 and 2 when it is only necessary to detect acceleration in two axes as disclosed herein. However, a three-axis accelerometer can be employed if the accelerometer is also employed for other functions, for example to detect the motion of the vehicle to assist with stability controls, or when motion is used as one of the determinants for keeping the lamp turned off. In the later embodiments, when motion of the vehicle is detected, this will cause the tilt switch to be locked in the off position. The motion data can also be used by other modules in the vehicle to activate systems such as traction control and braking, or other tilt switches that employ an accelerometer that only measures acceleration along a single axis or along two axes.

While the disclosed electronic tilt switch was developed for the automotive industry, beyond just automobiles, buses, recreational vehicles and trucks, it can also be applied with similar benefits to other types of vehicles such as trains, boats, industrial vehicles, agricultural vehicles, utility vehicles, military vehicles and airplanes. This disclosed electronic accelerometer-based tilt switch has advantages over known tilt switches because it uses only solid state electronics without any moving ball or sliding parts and the housing can be hermetically sealed so it can withstand being deployed in harsh environments. Recent advancements in accelerometer technology have also made the cost of accelerometers suitable for this application less expensive. MEMS based accelerometers can be made to meet or exceed automotive quality and performance specifications for a cost that is competitive with known tilt switches. Unlike accelerometers used by the automotive industry for air bags, which are calibrated for higher accelerations/decelerations, low cost accelerometers are now available that can detect the much smaller changes in gravitational forces along predetermined axes.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1: An electronic accelerometer-based tilt switch for vehicles capable of controlling the state of an electrical circuit according to the angle of inclination of said switch, comprising:
a housing mountable to a vehicle member that is movable between a first position and a second position, wherein when said vehicle member is in said first position it is at a predetermined angle of inclination versus when said vehicle member is in said second position;
an accelerometer disposed within said housing; and
a control circuit disposed within said housing and operatively connected to receive signals from said accelerometer indicative of an instant angle of inclination of said vehicle member and to switch the state of said electrical circuit to a first output state when said vehicle member is in a first position, and to switch the state of said electrical circuit to a second output state when said vehicle member is in said second position.

2: The electronic accelerometer-based tilt switch of claim 1 wherein said control circuit comprises electromechanical control devices configured to act as an electrical relay.

3: The electronic accelerometer-based tilt switch of claim 1 further comprising a microprocessor connected to receive signals from said accelerometer and wherein said microprocessor processes said signal to determine the angle of inclination of said vehicle member and is connected to send a command signal to said control circuit.

4: The electronic accelerometer-based tilt switch of claim 3 wherein said microprocessor is part of a microcontroller that also comprises program memory.

5: The electronic accelerometer-based tilt switch of claim 4 wherein said microcontroller is programmable with different thresholds for sending commands to said control circuit for different angles of inclination, whereby said electronic accelerometer-based tilt switch can be employed for different applications without any hardware changes.

6: The electronic accelerometer-based tilt switch of claim 1 wherein said accelerometer sends an output signal to a remote microcontroller, which is in communication with said control circuit.

7: The electronic accelerometer-based tilt switch of claim 1 wherein said accelerometer is a 3-axis accelerometer.

8: The electronic accelerometer-based tilt switch of claim 1 wherein said accelerometer is a MEMS cantilever beam accelerometer.

9: The electronic accelerometer-based tilt switch of claim 1 wherein said instant angle of inclination is determined based upon acceleration measured by said accelerometer along a predetermined axis.

10: The electronic accelerometer-based tilt switch of claim 1 wherein said control circuit is calibrated to determine that that said vehicle member has moved from said second position to said first position when said instant angle of inclination has changed by more than a predetermined threshold value.

11: The electronic tilt switch of claim 1 wherein said electrical circuit comprises a lamp assembly and said lamp assembly is turned on when said electrical circuit is in said first output state and turned off when said electrical circuit is in said second output state.

12: The electronic accelerometer-based tilt switch of claim 1 wherein said vehicle member is a hood for an engine compartment and said first output state is in association with a predetermined angle of inclination when said hood is in an open position.

13: The electronic accelerometer-based tilt switch of claim 1 wherein said vehicle member is a trunk or hatch lid and said first output state is in association with a predetermined angle of inclination when said trunk or hatch lid is in an open position.

14: The electronic accelerometer-based tilt switch of claim 1 wherein said vehicle member is an interior compartment door moveable to an open position at a first predetermined angle of inclination from a closed position at a second predetermined angle of inclination and said first output state is in association with said first predetermined angle of inclination.

15: The electronic accelerometer-based tilt switch of claim 1 wherein said control circuit maintains said second output state when the accelerometer signal value is greater than one by more than a predetermined threshold.

16: The electronic accelerometer-based tilt switch of claim 1 further comprising a motion sensor, wherein said control circuit maintains said second output state when said motion sensor indicates that the vehicle is in motion.

17: The electronic accelerometer-based tilt switch of claim 1 wherein said control circuit is programmed to filter noise from said signal received from the accelerometer.

18: The electronic accelerometer-based tilt switch of claim 1 wherein said control circuit applies an averaging filter to achieve said noise filtering.

19: The electronic accelerometer-based tilt switch of claim 1 further comprising an electrical connector for receiving electrical power from an external power source and delivering said electrical power to components within said housing.

20: The electronic accelerometer-based tilt switch of claim 19 wherein said electrical connector further comprises connections for sending and receiving signals from an external microprocessor.

21: The electronic accelerometer-based tilt switch of claim 1 further comprising a battery disposed inside said housing that provides electrical power to components within said housing.

22: The electronic accelerometer-based tilt switch of claim 11 wherein said lamp assembly is mounted inside said housing.

23: The electronic accelerometer-based tilt switch of claim 11 wherein said control circuit is configured to turn said lamp off after a predetermined time, even if the vehicle body remains in said first position.

24: The electronic accelerometer-based tilt switch of claim 11 wherein said control circuit causes a fade in effect when said lamp is turned on.
